(19) United States
(12) Patent Application Publication
(10) Pub. No.: US 2002/0101454 A1
(43) Pub. Date: Aug. 1, 2002

(54) Pre-audition CD

(76) Inventor: Marcus Suhwa Hong, Los Angeles, CA (US)

Correspondence Address: MARCUS HONG, 1032 S. MANSFIELD AVE., LOS ANGELES, CA, 90019, US

(21) Appl. No.: 09/772,227

(22) Filed: Jan. 30, 2001

(51) Int. Cl. G06F 3/00

(52) U.S. Cl. 345/810; 345/838

(57) ABSTRACT

A compact disc contains background and likeness information for actors, models, and musicians in the form of photographs, resumes, audio recordings and video/movie clips. By inserting the compact disc into a personal computer, the person responsible for hiring an actor/model/musician will be able to see displayed on the computer screen a more powerful profile of the actor/model/musician he or she is considering for a role or engagement. At the same time, it will enable the actor/model/musician to make a more effective impression by displaying his or her talents with one tool.

### BACKGROUND OF THE INVENTION

1. Field of the Invention

This invention is a new way of communicating the personal statistics and likenesses of actors, models and musicians through the use of computer technology and compact disks.

2. Prior Art

The standard method by which an actor/model/musician makes known his background is for him or his agent to distribute hard copies of black and white still photographs and resumes to hiring authorities in the entertainment industry. These representations have been strictly static and visual.

No method is known, however, for allowing an agent to communicate audio and moving video representations of his clients via compact discs, in a timely and efficient manner.

The assimilation of computer technology into every facet of the American economy has been occurring over the last 15 years. The evolution of computer technology has forced every industry to re-think how it conducts business. Like no other business, the entertainment industry has witnessed the complete and absolute integration of computer technology into itself. In fact, the entertainment industry is now a major source of new technology and inventions utilizing computer technology to its fullest potential.

Computer technology has more than assisted the creation of moviemega hits like Star Wars, Matrix, etc. In short, technology has completely revolutionized how special effects are created. With the advent of Pre-Audition CD, the entertainment industry will adopt a new auditioning process.

Pre-Audition CDs make use of the knowledge that the entertainment industry, like all major businesses, is utilizing computers to conduct business. With the cost of fully equipped computers falling every day, more and more companies are acquiring computers with CD ROM players making CD ROMs more accessible.

Pre-Audition CD is made using multiple graphic software programs such as After Effects, Commotion, Director, Illustrator, Macromedia, Photoshop, and Premiere.

### SUMMARY OF THE INVENTION

An object of this invention is to provide a method of presenting the background of actors, models and musicians, using compact discs to create a more effective representation through audio recordings, pictures, and video/movie clips.

Another object is to provide a method that allows the person casting the actors and actresses to save time in the screening process and to better make informed decisions when casting for roles.

A further object is to provide a method which will enable any actor, model or musician to make a more powerful first impression by displaying his or her multiple talents with one tool.

The foregoing objects can be accomplished by providing a Pre-Audition CD, which is simply a CD ROM containing pictures, video/movie clips, and audio recordings of an actor, model or musician. Pre-Audition CDs intend to replace the traditional black and whiteheadshots and resumes distributed by an actor, model or musician and/or by his/her agent. A Pre-Audition CD not only contains black and whiteheadshots and a resume, it will contain additional pictures, audio recordings and video/movie clips from previous assignments, as well as personal statistics.

These CDs will be produced in either normal size or custom shaped CD ROMs. This is dependent on the actor, model or musician.

A master Pre-Audition CD contains all the information mentioned above but is limited to just names, a few pictures, personal statistics, and resume. However, the master Pre-Audition CD will contain information on more than one actor/model/musician. It is only limited to the data storage capacity of the CD ROM.

It will include a built-in search engine for the viewer to search by categories, i.e. age, height, experience, etc. The viewer may download or tag an actor/model/musician' information for later use. Additionally, a web page will contain the rest of the information of an actor/model/musician that the viewer is interested in. Here too, a search engine will be included.

### BRIEF DESCRIPTION OF THE DRAWING

FIGS. 1 through 8 of the drawing illustrate the format for the screens displayed by the computer when the interactive Pre-Audition CD is used.

### DESCRIPTION OF THE PREFERRED EMBODIMENT

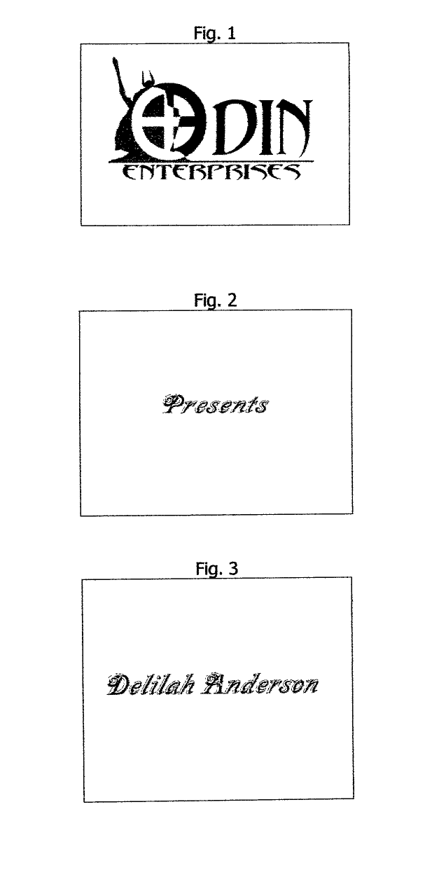

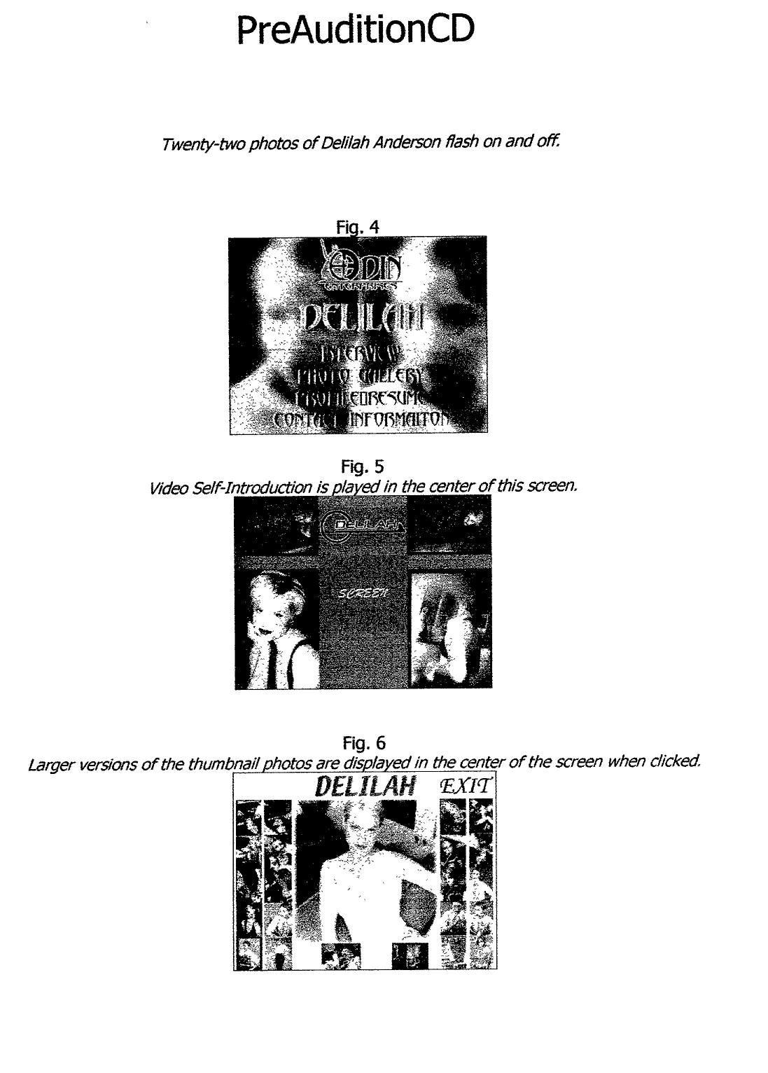

The preferred embodiment of the present invention will now be described in connection with FIG. 1 through FIG. 8 of the drawing. This embodiment utilizes the following computer equipment:

Personal Computer or Macintosh Computer;

At least one compact disc drive;

At least one display screen.

To start the Pre-Audition process, you simply insert the Pre-Audition CD in the CD-ROM tray of your computer. Automatically, the Pre-Audition CD will display the name of the actor/model/musician, as shown in FIG. 1 through FIG. 3., followed by a series of their still photographs that flash on and off, which can be enlarged, as shown in FIG. 6. In the case that the actor, model or musician has his/her own song(s), it will by played in the background throughout the Pre-Audition CD. If not, ambient music will be added.

The Main Menu page now appears, in the format shown in FIG. 4. This page contains the following click buttons labeled as:

a. Resume

b. Interview

c. Photo Gallery

d. Contact Information

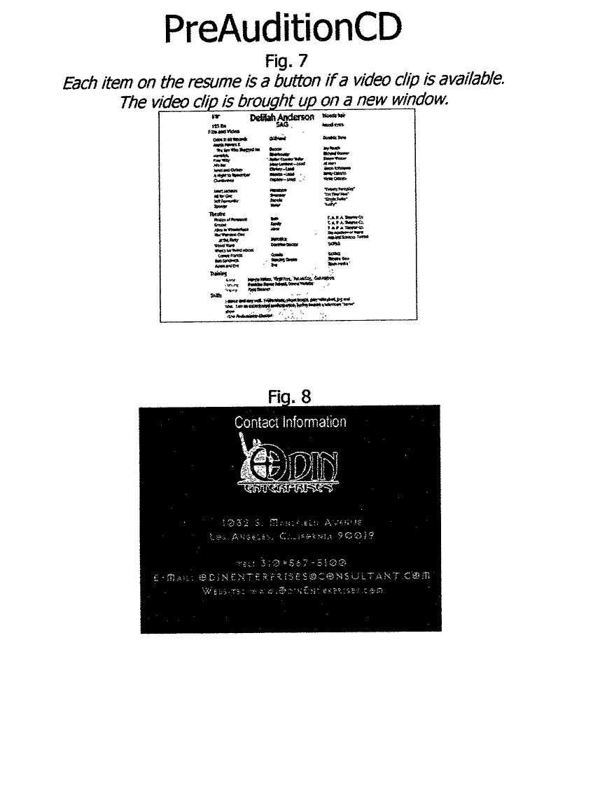

When the Resume button is clicked, a resume of the actor/model/musician will appear, as shown in FIG. 7. Items (previous work) listed on the resume act as buttons. Once clicked, a video clip associated with that previous work, if provided by the actor/model/musician, is played. After the video clip is played, the screen returns to the resume.

When the Interview button is clicked, a short self introduction by the actor/model/musician is played, in the form of a moving video with sound added. After the self introduction is played, the screen returns to the main menu page.

When the Photo Gallery button is clicked, the page containing thumbnail photos mentioned above appears, as shown in FIG. 6. When any one of these thumbnail photos are clicked, a larger version of the thumbnail photo is displayed in the center of the page.

To return to the Main Menu page, the “Exit” button must be clicked.

When the Contact button is clicked, a page appears that displays the actor/model/musician' contact information, as shown in FIG. 8: home, cell, and/or pager numbers. If desired by the actor/model/musician, a hyperlink to their e-mail address is made available.

To stop running the PreAudition CD, the “Quit” button must be clicked on the Main Menu page.

Once the “Quit” button is clicked, a credits page will be displayed with a hyperlink to Odin Enterprises' webpage.

Finally, an “Exit” button will fade-in to completely exit the PreAudition CD.

Master PreAuditionCD

Insert Master PreAudition CD in CD-ROM tray of your computer.

Fade in of music followed by a collage of headsets of actors and actresses are displayed with PreAudition CD's logo appearing from the background.

Simultaneously, a short audio introduction is played.

The first page is displayed with a description of the Master PreAudition CD. This page includes a search engine. Where the user can find potential actors/actresses by height, weight, ethnic look, body dimensions, etc.

Once the parameters of the search is completed, the user must click the submit button.

A list of thumbnail photos of actors or actresses are displayed. By clicking on the thumbnail photos, a resume and several other photos of the selected actor/model/musician will appear. Also, a “Contact” button will appear at the bottom of this page.

The “Contact” page is hyperlinked to PreAudition Webpage. Once on the PreAuition Webpage, the user is able to download and view the entire PreAudition CD of the selected actor/model/musician.

In order to make contact with the selected actor/model/musician, the user is required to submit their professional information to PreAudition CD's Webpage. An email with the user's professional information is emailed to the selected actor/model/musician.

What is claimed is:

1. A method of communicating the background and likenesses of actors and actresses through the use of compact discs, a personal computer having a display screen and using at least Windows 98 or Mac OS and at least one compact disc drive, said method referred to as Pre-Audition CD and comprising the steps of:
a) storing on the said compact discs the said likenesses and backgrounds of actors and actresses in the form of still photographs, audio recordings, video/movie clips and personal statistics utilizing graphic software programs such as After Effects, Commotion, Director, Illustrator, Macromedia, Photoshop, and Premiere.
b) displaying on said screen the name of the actor or actress as well as a series of their still photographs, after the user inserts the compact disc in the said compact disc drive.
c) displaying on said screen a main menu page, on which the user may select the following click buttons: Resume, Interview, Photo Gallery, and Contact Information.

2. The method defined in claim 1, wherein previous work of the actor/model/musician will appear as click buttons when said resume button is clicked.

3. The method defined in claim 2, wherein a video clip associated with the said previous work will be played on the said screen when the said click buttons are chosen.

4. The method defined in claim 1, wherein a short self introduction by the actor or actress is played on the said screen in the form of a moving video with sound added, when the said interview button is clicked.

5. The method defined in claim 1, wherein thumbnail photographs of the actor/model/musician appear on the screen when the said photo gallery button is clicked.

6. The method defined in claim 5, wherein a larger version of the said thumbnail photograph will appear on the screen when any one of these thumbnail photographs is clicked.

7. The method defined in claim 1, wherein the contact information for the actor/agent will appear on the screen in the form of home, cell, pager numbers, and/or E-mail address when the said contact button is clicked.

8. The method defined in claim 1, wherein the said compact discs may be produced in normal size or custom shaped, depending on the desires of the actor/model/musician.

9. The method defined in claim 1, wherein a variant of the Pre-Audition CD is created, termed the Master Pre-Audition CD.

10. The method defined in claim 9, wherein only still photographs, personal statistics, and resume in written form are stored on the compact disc.

11. The method defined in claim 10, wherein the compact disc includes the said information for more than one actor/model/musician.

12. The method defined in claim 11, wherein the compact disc includes a search engine whereby the user may search by various categories such as age, height, and experience.
